(19) United States
(12) Patent Application Publication
(10) Pub. No.: US 2005/0144986 A1
(43) Pub. Date: Jul. 7, 2005

(54) Method of making an optical fiber preform

(76) Inventors: Dana C. Bookbinder, Corning, NY (US); Lisa C. Chacon, Corning, NY (US); Adam J.G. Ellison, Painted Post, NY (US); Gregory G. Gausman, Wilmington, NC (US); Michael T. Murtagh, Horseheads, NY (US); William A. Whedon, Wilmington, NC (US)

Correspondence Address: CORNING INCORPORATED, SP-TI-3-1, CORNING, NY, 14831, US

(21) Appl. No.: 10/750,384

(22) Filed: Dec. 30, 2003

(51) Int. Cl. C03B 37/028

(52) U.S. Cl. 65/412; 65/419; 65/413; 65/421

(57) ABSTRACT

A method for manufacturing an optical fiber preform and fiber. According to the method, a first glass rod is formed, preferably by an OVD method, with a refractive index delta preferably between 0.2% and 3%. A glass sleeve tube is formed, preferably by an MCVD or PVCD method. The first glass rod is inserted into the sleeve and an alkali metal vapor is flowed between the sleeve tube and the first glass rod. Additional glass may optionally be formed on the inside surface of the sleeve tube prior to inserting the first glass rod and flowing the alkali metal vapor. The additional glass may be up-doped, down-doped, or both. The sleeve may then be collapsed onto the first glass rod to form a second glass rod doped with an alkali metal oxide. The second glass rod is drawn to form a third glass rod. Additional glass may then be formed on the third glass rod to form an optical fiber preform from which optical fiber may be drawn. Alternatively, the first glass rod is removed from the sleeve tube after flowing the alkali metal vapor and before the collapse step, after which additional glass may be formed on the first glass rod to form an optical fiber preform.

### BACKGROUND AND SUMMARY

1. Technical Field

This invention relates to a method for producing an optical fiber preform and fiber. More specifically, the method relates to efficiently producing optical fiber preforms and fibers doped with an alkali metal oxide.

2. Background of the Invention

Attenuation is a principal limiting attribute of optical fibers. Optical fiber loss, for example, plays an important role in setting the limiting distance between optical fiber amplifiers. This is particularly important in long distance and ultra-long distance networks such as, for example, undersea applications, where such amplifiers represent a significant system cost, as well as a major factor in system reliability. Consequently there is tremendous commercial interest in reducing attenuation to the lowest possible level.

Silica glass doped with an alkali metal oxide has been shown to be capable of reducing attenuation in optical fibers. Nevertheless, prior art methods of making optical fibers have been impractical for producing optical fiber preforms from which an alkali metal oxide doped optical fiber may be drawn as the alkali metal precursor compounds are impractical for direct deposition of alkali metal oxide doped soot to form preforms.

Manufacturing of optical fiber preforms, i.e., the article from which optical fiber is drawn, is typically accomplished by methods such as Outside Vapor Deposition (OVD), Vapor Axial Deposition (VAD), Modified Chemical Vapor Deposition (MCVD) and Plasma Chemical Vapor Deposition (PCVD). In accordance with one method, an optical fiber preform is formed by an OVD method. In the OVD method, silica-containing soot 20 is deposited onto a rotating and traversing mandrel 22 as indicated by arrows A and A′ of FIG. 2 to form a porous core soot preform 24. To form the soot 20, a glass precursor 26 is provided, preferably in gaseous form, to the flame 28 of a burner 30. The flame 28 is formed by combusting a fuel 32, such as methane, while providing a combustion supporting gas, such as oxygen 34. The core soot preform 24 may be up-doped with a dopant such as germania oxide, for example, to raise its refractive index. This may be accomplished, for example, by providing a glass precursor 26, such as SiCl₄, to the burner 30 in gaseous form along with a gaseous dopant compound, such as GeCl₄. The doped silica-containing soot preform 24 is then dried and consolidated in a consolidation furnace 32, such as shown in Prior Art FIGS. 3 and 4 to form a consolidated core blank 34. A helium and chlorine gas atmosphere, for example, in the consolidation furnace is used to dry the preform and remove water prior to vitrification into glass at a temperature of about 950° C. to 1250° C. Pure helium is generally provided during consolidation and the temperature is higher, for example, between about 1390° C. to 1535° C.

Following consolidation, next, as shown in FIG. 5, the consolidated core blank 34 is placed in a cane draw furnace 36 and is stretched into a length of core cane 38 from which multiple core cane segments 40 are derived. At the same time, the centerline aperture is closed by application of, for example, a vacuum. The draw tension and preform downfeed rates (indicated by arrow B) are controlled by suitable control method 42 to provide a core cane length 38 of preferably substantially constant, predetermined diameter dₒ. The diameter dₒ is controlled by feedback of a measured diameter signal from an appropriate non-contact sensor 44 to the control apparatus 42. In response, the controls 42 may adjust the tension applied at the tension apparatus 46 whereby lowering the tension raises the diameter dₒ and raising the tension lowers the diameter dₒ. At predetermined lengths, the cane is cut, such as by a flame cutter 48, to form a predetermined length core cane segment 40 (FIG. 6). This core cane 40 represents the first segment 10 of the final preform, as illustrated in FIG. 1.

In the final step, the core cane segment is overclad with silica-containing soot. This step looks identical to FIG. 2 except that the mandrel is now the previously made core cane 40. The soot deposited is preferably silica soot formed by providing the glass precursor 26 such as SiCl₄ to the flame 28 and oxidizing the precursor to form SiO₂. Next, the soot-laden core cane 50 is placed in a furnace 52 as is described in Berkey U.S. Pat. No. 4,629,485 and is consolidated, as shown in FIG. 7. Preferably the overcladding comprises essentially SiO₂. The soot preform is dried and consolidated as heretofore mentioned to form the final consolidated optical fiber preform 54. The resulting final consolidated preform 54 is then placed in a draw furnace 56 as shown in FIG. 8, heated and drawn into an optical fiber 58 in a helium gas atmosphere by conventional methods and apparatus. The fiber 58 is then cooled in cooling chamber 60 and measured for final diameter by non-contact sensor 62. One or more coatings are applied and cured by coating apparatus 64, as is also conventional. During draw, the fiber 58 passes through a tension assembly 66 whereby tension is applied to draw the fiber 58 from the preform 54. The tension is controlled via control apparatus 68 to maintain the fiber diameter at a predetermined set point. Finally, the coated fiber 70 is wound by feedhead 72 onto a fiber winding spool 74.

### SUMMARY OF THE INVENTION

One broad aspect of the invention includes a method of making an optical fiber preform comprising the steps of inserting a first glass rod into a first glass tube, heating the first glass rod and the first glass tube; and flowing a carrier gas comprising oxygen and an alkali metal vapor between the first glass rod and the first glass tube wherein the alkali metal vapor comprises an alkali metal selected from the group consisting of K, Na, Li, Cs, Rb, and combinations thereof. Preferably, the water content of the first glass rod is less than about 100 ppb; more preferably less than about 20 ppb. The first glass rod preferably comprises less than about 0.05 wt. % chlorine; more preferably less than about 0.02 wt. %; and most preferably less than about 0.01 wt. %.

The manufacturing method in accordance with a first embodiment of the invention comprises the steps of forming a first glass rod, or core cane segment, which preferably has a germania dopant therein, providing a delta of between about 0.2%-3%, inserting the segment into a first glass tube (sleeve), preferably formed by an inside method such as MCVD or PCVD, doping the rod-tube assembly with an alkali metal oxide, and then collapsing the sleeve onto the rod to form a second glass rod. The second glass rod preferably comprises an alkali metal oxide in a peak concentration of at least about 0.01 wt. %; more preferably at least about 0.1 wt. %; and most preferably between about 0.1 wt. % and 5 wt. %. The second glass rod may then be drawn to form a third glass rod. Additional glass may be formed on the third glass rod to form an optical fiber preform. The optical fiber preform may be drawn into an optical fiber by conventional drawing methods.

The first glass rod, in accordance with the invention, is preferably formed by an OVD method wherein a core soot region is formed by depositing silica-containing soot onto an outside of a rotating deposition surface, the core soot region is then dried and consolidated in a consolidation furnace to form a consolidated core blank, followed by drawing from the consolidated core blank the core cane segment having an outer dimension dₒ.

In accordance with another embodiment of the invention, the first glass rod may be removed from the first glass tube at the completion of the alkali metal oxide doping step, after which additional glass may be formed on the first glass rod. The first glass rod preferably comprises an alkali metal oxide in a peak concentration of at least about 0.01 wt. %; more preferably at least about 0.1 wt. %; and most preferably between about 0.1 wt. % and 5 wt. %. Preferably, the additional glass is formed by depositing soot. The glass soot may then be dried and consolidated to form an optical fiber preform. The optical fiber preform may be drawn into an optical fiber doped with an alkali metal oxide. Alternatively, the additional glass may be formed by inserting the first glass rod into a second glass tube, and collapsing the glass tube onto the first glass rod to form and optical fiber preform. The optical fiber preform may then be drawn into an optical fiber doped with an alkali metal oxide.

In accordance with another embodiment of the invention, a method of manufacturing a multi-segment optical fiber doped with an alkali metal oxide is provided comprising the steps of forming a first glass rod by depositing silica-containing soot onto an outside of a rotating deposition surface to form a soot preform, consolidating the soot preform in a consolidation furnace thereby forming a consolidated blank, drawing from the consolidated blank to form at least one glass rod (core cane segment) having an outer dimension dₒ; forming additional layers of glass on an inside of a first glass tube (sleeve) wherein the sleeve tube includes one or more down-doped radial portions and one or more up-doped radial portions, preferably as compared to silica, inserting the first glass rod into the first glass tube, flowing an alkali metal vapor between the core cane and the sleeve tube, and collapsing the sleeve tube around the first glass rod to form a second glass rod. The second glass rod preferably comprises an alkali metal oxide in a peak concentration of at least about 0.01 wt. %; more preferably at least about 0.1 wt. %; and most preferably between about 0.1 wt. % and 5 wt. %. The second glass rod may then be drawn to form a third glass rod comprising multiple core segments, forming cladding glass on an outside of the third glass rod to form an optical fiber preform, and drawing the optical fiber from the optical fiber preform. It should be recognized that the one or more down-doped portions may include a moat and a gutter, for example. Further, the one or more up-doped portions may include multiple spaced rings.

Other features and details of the present invention will be apparent from the appended specification, claims and drawings.

### BRIEF DESCRIPTION OF THE FIGURES

FIG. 1 illustrates a schematic depiction of a single segment profile in accordance with the prior art.

FIG. 2 illustrates a prior art OVD method for forming a soot preform.

FIGS. 3 and 4 illustrates partially cross-sectioned side views of a soot preform and a consolidated core blank in accordance with the prior art.

FIG. 5 illustrates a partially cross-sectioned side view of a core cane draw furnace in accordance with the prior art.

FIG. 6 illustrates a cross-sectioned side view of a core cane segment in accordance with the prior art.

FIG. 7 illustrates a partially cross-sectioned side view of a preform in a consolidation furnace in accordance with the prior art.

FIG. 8 illustrates a partial cross-sectioned side view of an optical fiber draw apparatus in accordance with the prior art.

FIG. 9 illustrates a perspective view of a process of assembly of the core cane into the sleeve in accordance with the present invention.

FIG. 10 illustrates a cross sectional side view of exposing a core cane segment and a sleeve assembly to an alkali metal vapor in accordance with an embodiment of the present invention.

FIG. 11 illustrates a cross section view of an apparatus for supplying an alkali metal vapor in accordance with the present invention.

FIG. 12 illustrates a schematic partially cross-sectioned view of the step of collapsing a cladding tube onto the multi-segmented core cane preform in accordance with an embodiment of the present invention.

FIG. 13 illustrates a partially cross-sectioned side view of a core cane draw assembly for producing a core cane in accordance with the present invention.

FIG. 14 illustrates a partially cross-sectioned view of an assembly for silica cladding the core cane in accordance with an embodiment of the present invention.

FIG. 15 illustrates a perspective view of the assembly of a length of the core cane into a silica cladding tube in accordance with an embodiment of the present invention.

FIG. 16 illustrates a cross sectional view of the soot preform being consolidated in accordance with an embodiment of the present invention.

FIG. 17 illustrates a cross-sectional side view of the consolidated preform in accordance with an embodiment of the present invention.

FIG. 18 illustrates a schematic partially cross-sectioned view of the step of collapsing a cladding tube onto the multi-segmented core cane preform in accordance with an embodiment of the present invention.

FIG. 19 illustrates a perspective view of an embodiment of the consolidated preform in accordance with an embodiment of the present invention.

FIG. 20 illustrates a schematic depiction of a relative refractive index profile of a consolidated preform of FIG. 19.

FIG. 21 illustrates an MCVD method of forming additional glass layers in a glass tube to form a sleeve tube.

FIG. 22 illustrates a sleeve tube having multiple layers of up-doped and/or down-doped glass deposited on an inside surface of the tube.

FIG. 23 illustrates a PCVD method of forming additional glass layers in a glass tube to form a sleeve tube.

FIG. 24 illustrates a relative refractive index profile of an optical fiber having multiple core segments.

### DETAILED DESCRIPTION OF THE INVENTION

Reference will now be made in detail to the present preferred embodiments of the invention with reference to the attached drawings. Wherever possible, the same or similar reference numerals shall be used throughout to refer to the same or like parts.

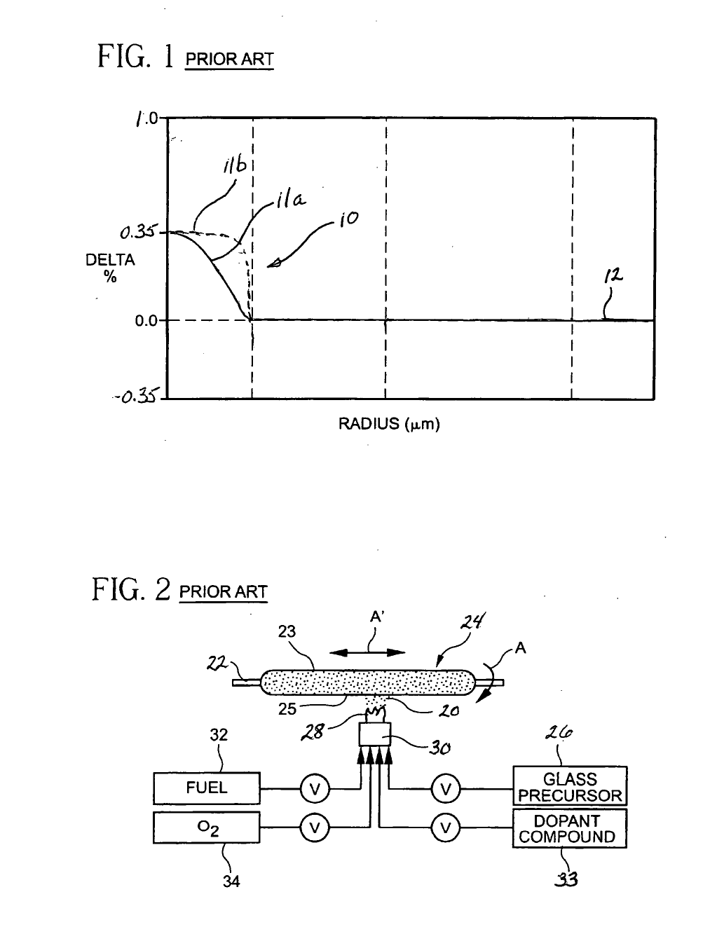

According to a first embodiment of the present invention, a method of manufacturing an optical fiber preform doped with an alkali metal oxide is provided. As best illustrated in FIGS. 2-5, the method for forming the optical fiber preform comprises a first step of forming at least one core cane segment 40 having an outer dimension dₒ. The core cane is preferably formed in accordance with the prior art OVD method described herein. In particular, a core soot region 23 is formed by depositing doped silica-containing soot 20 onto an outside of a relatively rotating and translating deposition surface 25. At first, the surface is a tapered mandrel and thereafter is the surface of the soot already deposited. The soot 20 is formed by providing a glass precursor 26 in gaseous form to the flame 28 of a burner 30 to oxidize it. Fuel 32, such as methane (CH₄), and combustion supporting gas 34, such as oxygen, are provided to the burner 30 and ignited to form the flame 28. Mass flow controllers, labeled V, meter the appropriate amounts of suitable dopant compound 33, glass precursor 26, fuel 32 and combustion supporting gas 34, all preferably in gaseous form, to the burner 30. The glass former compounds 26, 33 are oxidized in the flame 28 to form the generally cylindrically-shaped soot region 23. In particular, it is desirable that the dopant compound 33 includes an index raising dopant, such as a germanium compound.

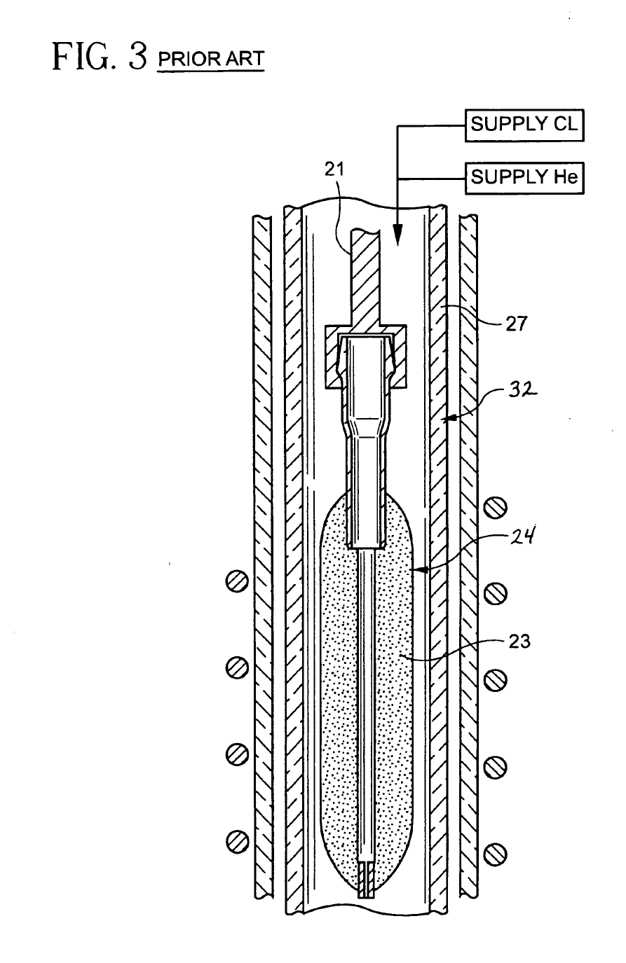

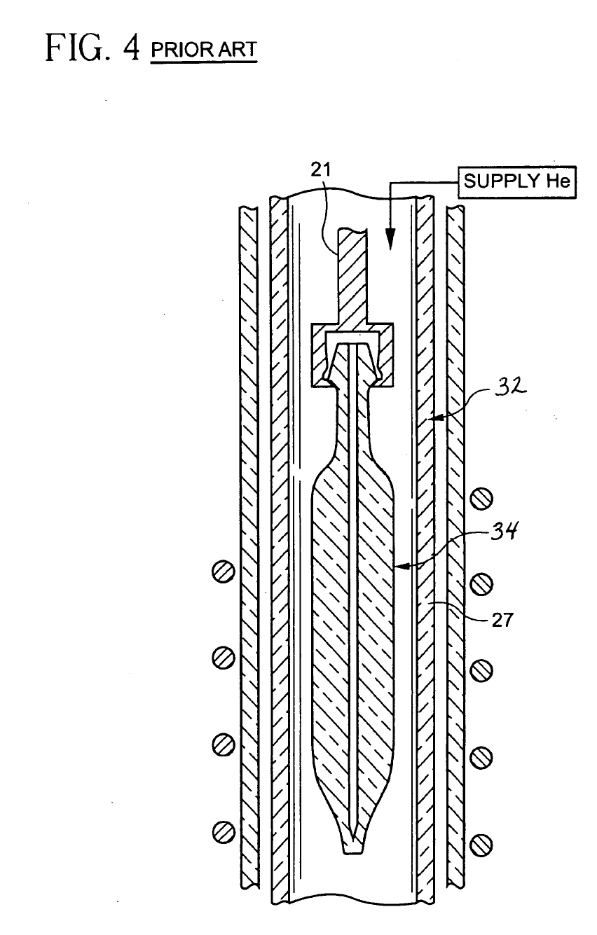

Next, the soot preform 24 including the soot region 23 is consolidated in a consolidation furnace 32 thereby forming a consolidated core blank 34 as is shown in FIGS. 3 and 4. The soot preform 24 is suspended inside a pure quartz muffle tube 27 of the furnace 32 by a holding mechanism 21 and exposed to a drying atmosphere of about 98% to 99% helium and 1% to 2% % chlorine gas at a temperature of between about 950° C. and 1250° C. for between about 0.5 and 4.0 hours. The furnace temperature is then raised and the preform 24 is consolidated preferably in an atmosphere of pure helium at a temperature of between about 1390° C. and 1535° C. to form the consolidated core blank 34. Preferably, gradient sintering is employed whereby the soot preform 24 is driven down through a hot zone of the furnace 32 at a rate of about 2-20 mm/minute.

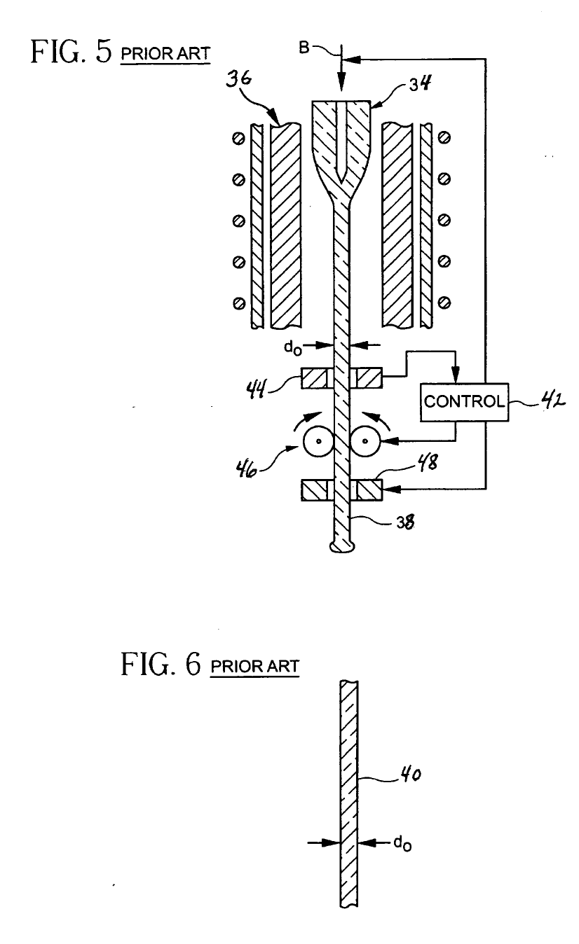

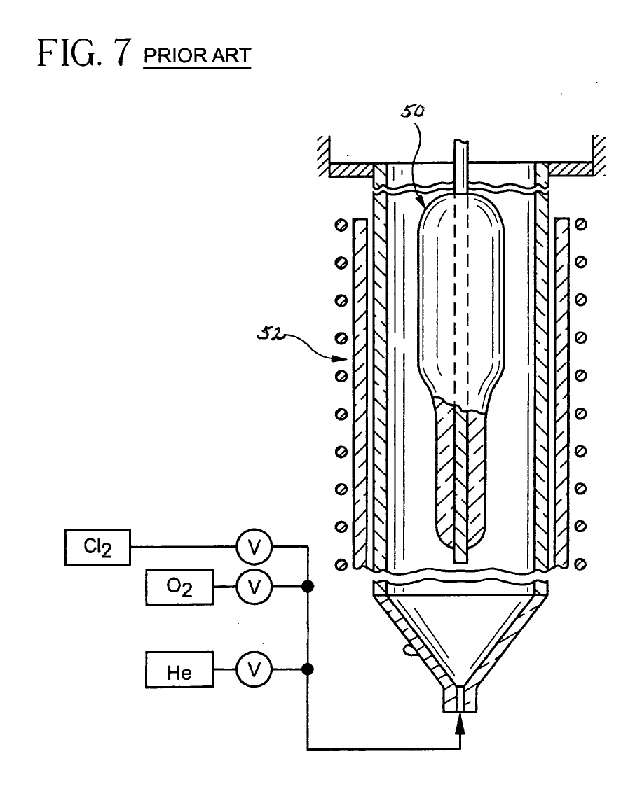

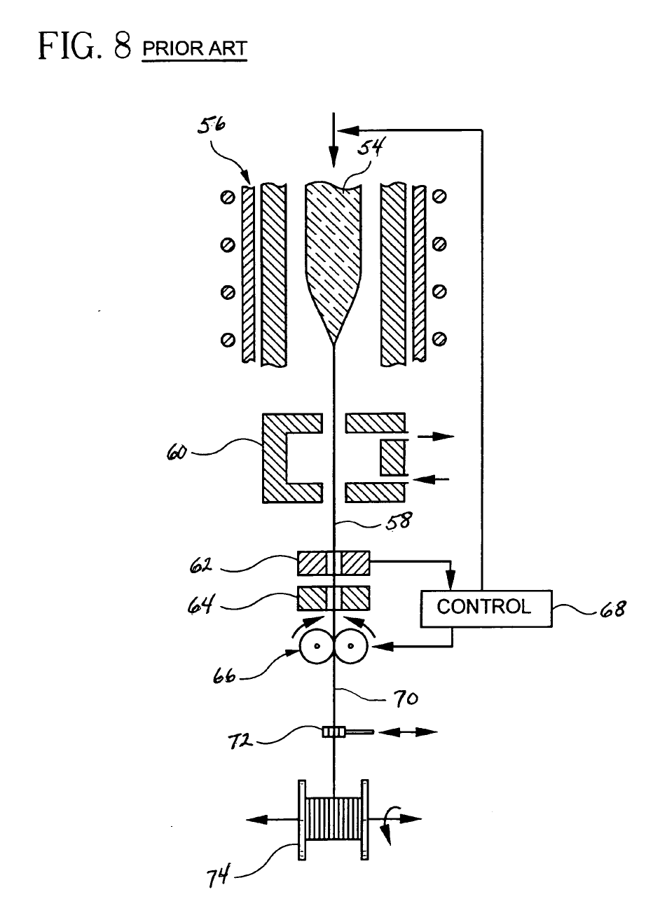

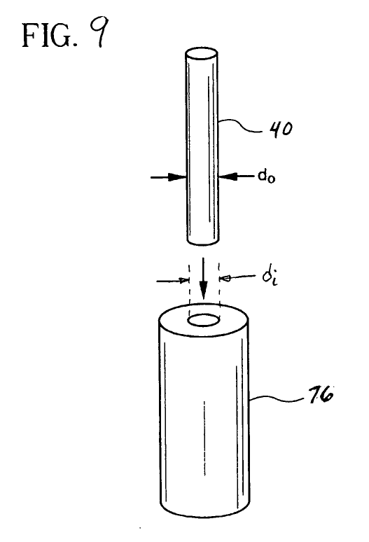

As illustrated in FIGS. 5 and 6, the consolidated core blank 34 is next placed in a core cane draw furnace 36 and at least one rod-shaped core cane segment 40 (FIG. 6) having an outer dimension dₒ is drawn therefrom. The preform blank 34 is heated to a temperature between about 1700° C. and 2000° C. until a gob drops. Once a suitable amount of trash glass is stripped, the controls 42 then control the tension applied to the cane by suitable control signals to a tension mechanism 46, shown here as two tractor wheels, to draw down the cane 38 at the proper speed. In this way, it is possible to derive a length of core cane 38 having an outer diameter dimension of between about 1 mm and 10 mm.

The diameter of core cane 38 is monitored by a non-contact sensor 44 and provides to the control system 42 a signal thereof. The controls 42 compare the sensed diameter signal from sensor 44 to a predetermined set diameter stored in memory and thereafter commands an appropriate adjustment, if any, to the tension to maintain the set diameter dₒ. Controls 42 also control the down feed rate of the blank 34. Preferably, that rate is held constant. Arrow B indicates the down feed of the blank 34. As a predetermined length of the core cane 38 passes through the tension assembly 46, as determined by the controls, a cutter 48, such as a flame cutter, is activated. The cutter severs the cane 38 into predefined lengths of core cane segments 40 (FIG. 6). It should be recognized that the core cane 40 produced corresponds to the innermost core of the preform and fiber and preferably includes the germania dopant. In a preferred embodiment, the core cane segment 40 has a Δ₁ of between 0.2% and 3% as compared to the silica cladding, where Δ_{c}=0 and Δ₁=(n₁−n_{c})/n_{c}, where n₁ is the peak refractive index of the first segment 10, and n_{c} is the refractive index of the cladding 12. First segment 10 may have a parabolic profile (11a), or a step-like profile (11b). Preferably, core cane segment 40 comprises less than about 100 ppb by wt. of water; more preferably less than about 20 ppb by wt. By water we mean the hydroxyl radical OH. OH is responsible for an absorption peak at or about 1383 nm and which absorption peak may extend into one or more operating wavelength regions of an optical fiber. This absorption peak may have a detrimental effect on the optical loss, or attenuation, of an optical fiber which may eventually be formed from core cane segment 40. Preferably, core cane segment 40 comprises less than about 0.05 wt. % Cl; more preferably less than about 0.02 wt. %; most preferably less than about 0.01 wt. %.

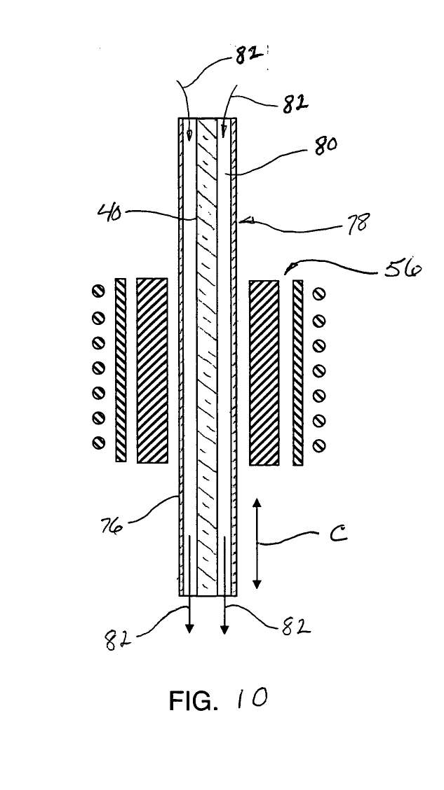

In accordance with the next step in the method invention, the core cane segment 40 of FIG. 10 having a dimension dₒ of between about 1 mm and 10 mm, preferably between about 5 mm and 10 mm, and more preferable between about 8 mm and 10 mm, is inserted into glass sleeve tube 76, as is illustrated in FIG. 9. The sleeve 76 has an inner dimension dᵢ of between about 17 mm and 26 mm. Core cane segment 40 is positioned concentrically within sleeve 76. In some cases it may be desirable to decrease the diameter of sleeve tube 76, and therefore dᵢ, prior to inserting core cane segment 40 into sleeve 76. Preferably, the distance between an inside surface of sleeve 76 and an outside surface of core cane segment 40 is less than about 8 mm, more preferably less than about 5 mm, and most preferably less than about 3 mm. This may be accomplished, for example, by heating sleeve tube 76 on a conventional glass working lathe or by heating sleeve tube 76 into a suitable furnace. Glass sleeve 76 may be substantially pure silica, or glass sleeve 76 may comprise one or more dopants. For example, glass sleeve 76 may comprise F or Ge. Preferably, glass sleeve 76 comprises less than about 0.05 wt. % Cl; more preferably less than about 0.02 wt. %; most preferably less than about 0.01 wt. %. Preferably, glass sleeve 76 comprises less than about 100 ppb by wt. of water; more preferably less than about 20 ppb by wt.

In the next step of the present method, as best shown in FIG. 10, the nested sleeve 76 and core cane 40, which form assembly 78, are inserted in the draw furnace 56 and assembly 78 is heated while a mixture of carrier gas and alkali metal vapor 82 is flowed through a space 80, as indicated by arrows 82, formed between the core cane segment 40 and the sleeve 76. The alkali metal vapor is transported through space 80 by a carrier gas comprising oxygen. The carrier gas may also comprise an inert gas, such as argon or helium. The carrier gas preferably comprises at least about 15% oxygen; more preferably at least about 20% oxygen. However, oxygen concentrations of up to 100% may be used. The carrier gas is preferably flowed at greater than about 0.5 standard liters per minute (SLPM); more preferably between about 0.5 and 1.0 SLPM.

The alkali metal vapor may be formed by heating a suitable alkali metal source compound. The alkali metal source compound preferably comprises an alkali metal selected from the group consisting of K, Na, Li, Cs, Rb, and combinations thereof. Preferably, the alkali metal source compound is an iodide or bromide of the alkali metal. For example, the alkali metal source compound may be KBr, or KI. In the embodiment shown in FIG. 12, a chamber 84 for heating the alkali metal source compound is connected at one end of assembly 78. Chamber 84 contains a predetermined amount of alkali metal source compound 86 and is heated by heat source 88. For example, at least about 25 g of alkali metal source compound may be used in chamber 84; more preferably at least about 35 g, most preferably at least about 50 g. Heat source 88 may be, for example, a combustion burner or a resistance heater. The oxygen containing carrier gas 85 is flowed into chamber 84 where the carrier gas mixes with and transports the alkali metal vapor through space 80. As the oxygen contained within the carrier gas contacts the heated alkali metal vapor, an alkali metal oxide is formed. The alkali metal oxide contacts and diffuses into the inside surface of sleeve 76 and the outside surface of cane 40, thereby forming an alkali metal oxide doped glass.

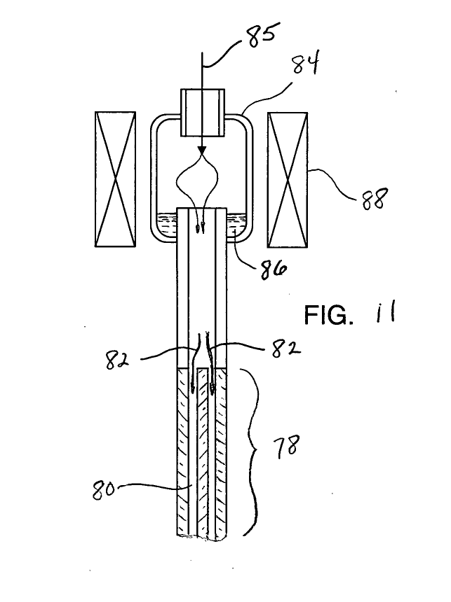

Preferably, relative motion is provided between assembly 78 and furnace 56 as indicated by arrow C in FIG. 11. For example, relative motion may be obtained by passing assembly 78 through furnace 56. Alternatively, assembly 78 may be stationary while furnace 56 moves parallel to the longitudinal axis of assembly 78. Both assembly 78 and furnace 56 may move to provide relative motion. In a preferred embodiment, assembly 78 is passed through furnace 56 for at least one pass while the mixture of carrier gas and alkali metal vapor flows through space 80; more preferably at least about 2 passes, more preferably still, at least three passes; and most preferably at least four passes. Preferably, the temperature of furnace 56 is at least about 2000° C., more preferably at least about 2040° C.; and most preferably at least about 2100° C. Preferably, the relative motion between assembly 78 and furnace 56 is at least about 1 cm/s, more preferably at least about 2 cm/s; and most preferably at least about 3 cm/s.

In the next step of the present method, as best shown in FIG. 12, assembly 78 is inserted in the draw furnace 56 and sleeve 76 is heated and collapsed around core cane segment 40. This forms optical fiber precursor 90. The temperature in furnace 56 is preferably set between about 1700° C. and 2100° C. The collapse step may be accomplished, for example, by moving assembly 78 through furnace 56. Alternatively, the step of collapsing to form optical fiber precursor 90 may be performed in a lathe (not shown) by passing a suitable heat source along the nested segment and sleeve while simultaneously rotating them. Preferably, precursor 90 comprises an alkali metal oxide dopant in a peak concentration of at least about 0.01 wt. %; more preferably at least about 0.1 wt. %; and most preferably between about 0.1 wt. % and 5 wt. %.

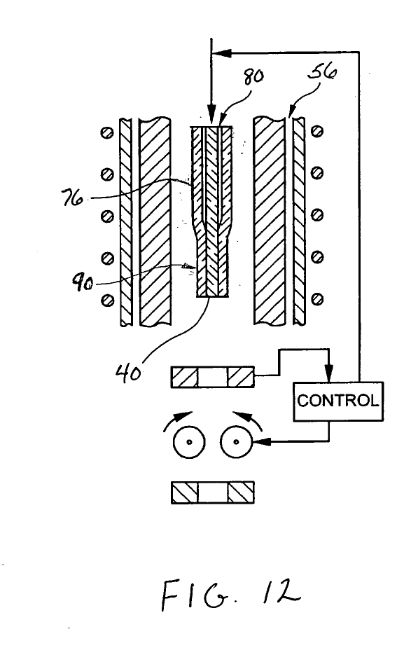

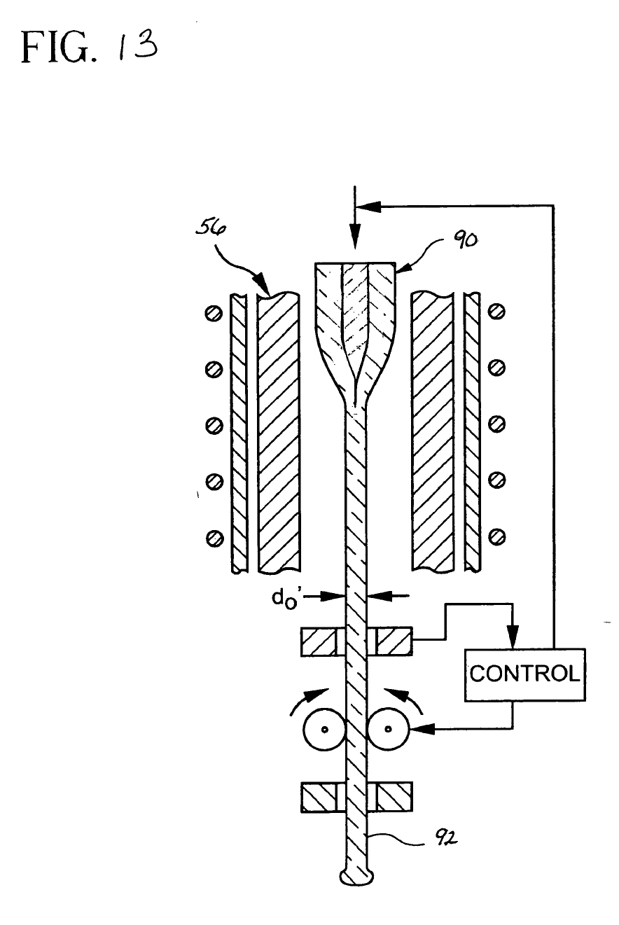

Next, as best shown in FIG. 13, after the step of collapsing, optical fiber precursor 90 is stretched in, for example, draw furnace 56 to form a length of cane 92. The length of cane 92 is drawn to a diameter dimension of dₒ′ as shown in FIG. 13. Multiple core canes 94 are cut from the length 92. These segments 94 then have silica-containing cladding applied thereto to form on an outside cladding thereof.

In a preferred embodiment, silica-containing cladding soot 122 is applied to the outside of cane segment 94 in a conventional OVD process, as shown in FIG. 14. In the OVD process, glass precursor 143, such as SiCl₄ or octamethylcyclotetrasiloxane, is provided in gaseous form to burner 126. Burner flame 130 oxidizes precursor 143 and forms silica-containing soot 122. Soot 122 is deposited onto the outside of rotating length 94 by the traversing burner (as indicated by arrow E) to the appropriate predetermined thickness to form overclad soot preform 120.

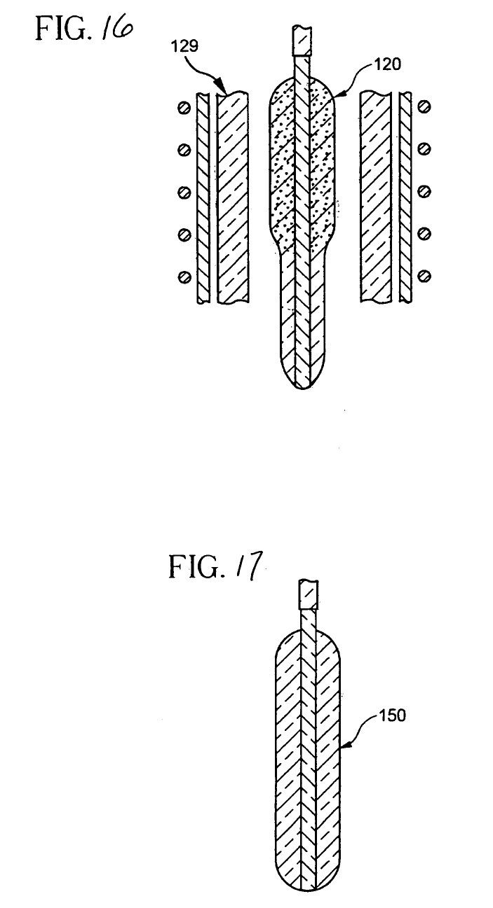

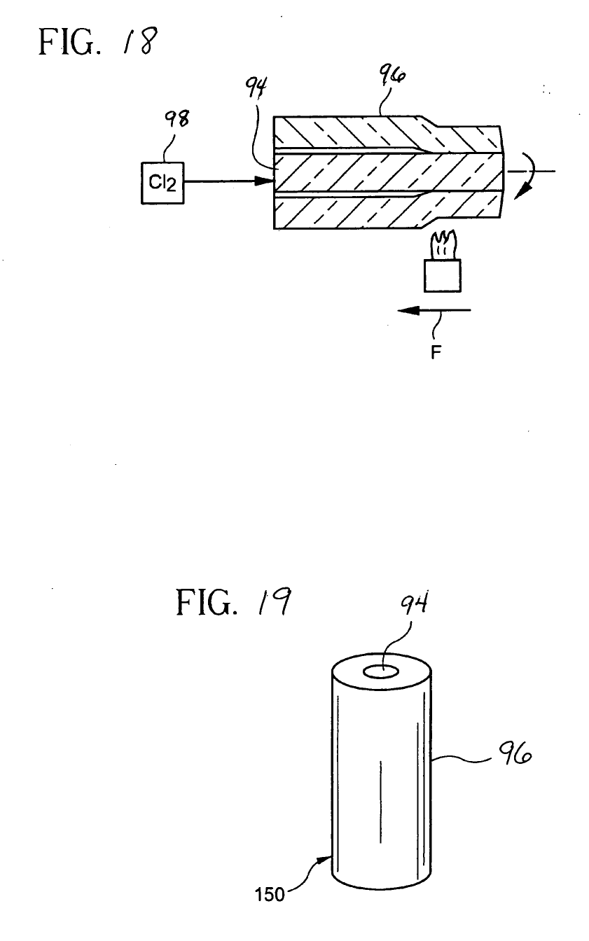

As best shown in FIG. 17, soot-laden preform 120 is inserted in a consolidation furnace 129 and gradient sintered in a hot zone having a temperature of between about 950° C. and 1535° C. at a down drive speed of about 2-20 mm/minute, and most preferably about 5 mm/minute. The result is consolidated preform 150, as best shown in FIG. 18.

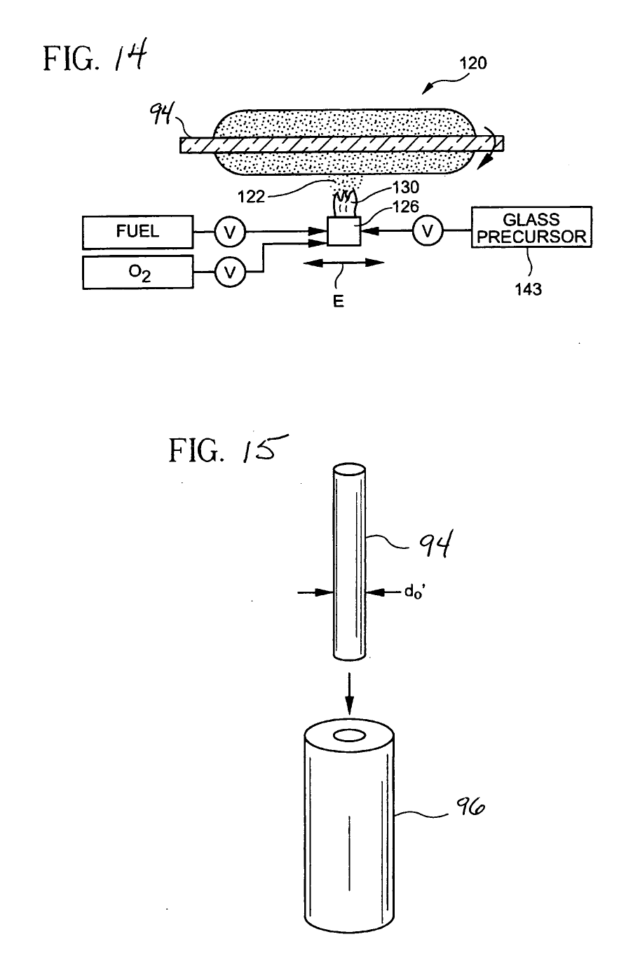

In an alternate method, as best shown in FIGS. 15 and 18-19, the length of core cane 94 is inserted into a silica-containing glass cladding tube 96 (FIG. 16). Then, cladding tube 96 is collapsed onto cane segment 94 to form preform 150. Preferably, this is accomplished in a suitable lathe apparatus (not shown for clarity). The cladding tube 96 and cane segment 94 are simultaneously rotated in the lathe and subjected to sufficient heat from a flame or other heat source traversing along the length as indicated by arrow F. A chlorine gas 98 may be provided to the gap between the cane 94 and tube 96 prior to the step of collapsing. The result is an optical fiber preform 150 including the core cane 94 and silica-containing cladding tube 96 which is now ready for being transferred to a draw furnace to draw optical fiber therefrom. Optical fiber is drawn from the preform 150 in a conventional manner as was earlier described with respect to FIG. 8.

Thus, it should be recognized that the method in accordance with this embodiment of the invention provides for manufacturing an optical fiber preform doped with an alkali metal oxide by forming a core cane, forming the sleeve tube, inserting the core cane into the sleeve, flowing a mixture of oxygen and an alkali metal vapor between the core cane and the sleeve, and collapsing the sleeve around the core cane to form an optical fiber precursor. Next, the optical fiber precursor is stretched into a second core cane. A cladding portion is then formed around the second core cane to form an overclad assembly, and the overclad assembly is consolidated to form the alkali metal oxide doped optical fiber preform. The preform is then drawn into optical fiber in accordance with conventional methods as shown in FIG. 8, for example.

In addition to these embodiments, persons skilled in the art can see that numerous modifications and changes may be made to the above invention without departing from the intended scope thereof. For example, in another embodiment, core cane 40 may be removed from sleeve 76 before the collapse step of sleeve 76. Additional glass may then be formed on core cane 40 in the method shown, for example, in FIG. 2. Preferably, the additional glass is formed by depositing soot onto the glass core cane 40. Preferably, the glass soot is substantially pure silica. The resulting core cane-soot body is consolidated to form an optical fiber preform which may be drawn into an optical fiber in accordance with the method depicted in FIG. 8.

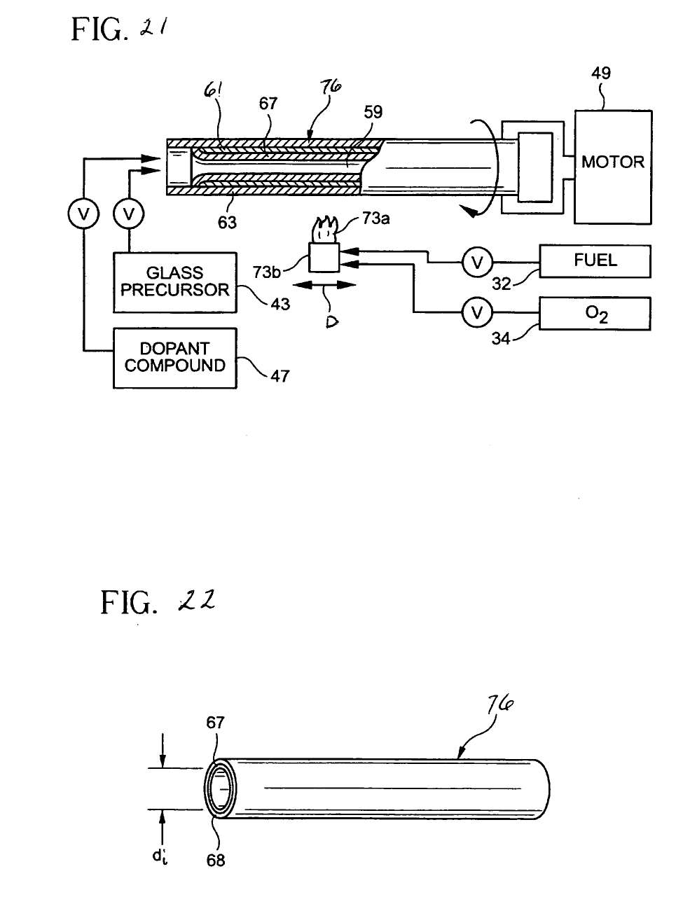

In yet another embodiment, as best illustrated in FIGS. 21-24, one or more additional glass layers may be formed on an inside of a glass tube 63 to form sleeve tube 76 prior to inserting core cane 40 into glass sleeve 76. The glass sleeve tube 76 preferably includes a down-doped inner radial portion 67, as compared to silica, formed at an inner portion of sleeve 76, and a outer radial up-doped portion 61, as compared to silica, formed at an outer portion of the sleeve 76. In the FIG. 21 embodiment, the glass sleeve tube 76 is formed by introducing gaseous glass precursor, such as SiCl₄ and, preferably, a dopant compound into the end and inside cavity 59 of the glass tube 63. The glass precursor 43 and dopant compound 47 are provided in gaseous form to dope the glass to achieve the desired refractive index profile for the sleeve 76 as a function of radial dimension thereof.

In particular, the up-doped segment 61 is preferably formed by providing an index-raising dopant compound 47, such as a germanium-containing dopant compound, in gaseous form into the cavity of glass tube 63 along with the glass precursor 43. One preferred compound is GeCl₄. Others include Cl₂, POCl₅, TiCl₄, AlCl₃ or any other suitable index-raising dopant.

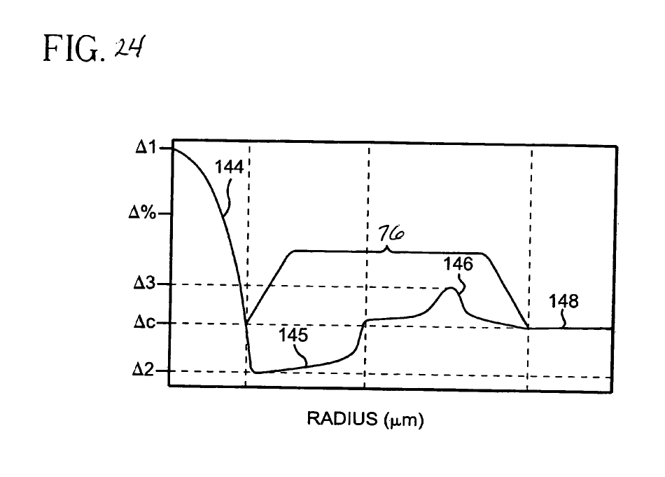

The down-doped segment 67 is next formed by introducing an index-lowering dopant compound 47, such as F₂, CF₄, C₂F₄, SF₆, SiF₄, C₂F₆ or any other suitable fluorine-containing compound in gaseous form into the inner cavity of the tube 63. As the glass precursor 43 (e.g. SiCl₄) and dopant compound 47 are introduced into glass tube 63, the tube is rotated by a motor 49 at rotational speed of between about 20 and 60 rpm. Soot is formed in the tube and, by the aid of an axially traversing flame 73a of a burner 73b that moves along the length of the tube 63 (as indicated by arrow D), the soot is heated and substantially simultaneously converted into consolidated glass on the inside of tube 63. The burner 73b operates on any suitable fuel 32, such as CH₄, and suitable combustion supporting gas 34, such as O₂. Other gases may be included such as C₂H₂, H₂, and/or N₂. Preferably, sleeve tube 76 has the refractive index profile as indicated in FIG. 24 thereby providing at least one up-doped segment 146 and at least one down-doped segment 145, as shown. FIG. 24 also shows a central core segment 144, formed from core cane 40, and cladding 148, which may be added at the completion of the draw step during which the optical fiber precursor is formed, as previously described. Preferably, the down-doped segment of the sleeve 76 is achieved by including a fluorine dopant. In particular, it is desired that down-doped moat segment include a Δ₂ between about −0.1% and −1.2%. Sleeve tube 76 is shown in FIG. 22. Once the layers 67 and 61 are formed inside of tube 63, glass tube 63 remains as part of sleeve 76. Core cane segment 40 may then be inserted into sleeve 76 as previously described.

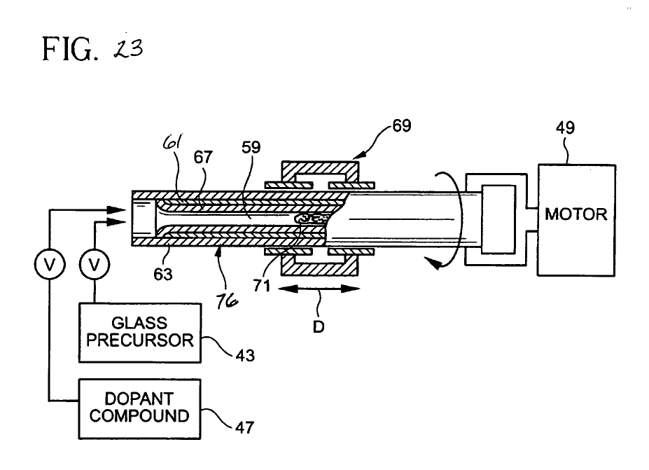

Alternatively, the sleeve 76 may be produced by a Plasma Chemical Vapor Deposition (PCVD) method, as shown in FIG. 23. In the PCVD method, a glass precursor 43 and dopant compound 47 are provided into cavity 59 of the silica glass tube 63 in gaseous form as in the before-mentioned MCVD process of FIG. 21. However, in this case, the cavity of the silica tube 63 is held at a low pressure (typically 10-20 Torr) and energy is provided by a microwave resonator 69 (typically powered by 2-6 kW). The microwave resonator 69 surrounds the tube 63, and directs microwaves through the wall of the tube 63 to produce plasma 71 within the tube 63. The microwaves heat the inside of the tube 63 and the gases to about 1200° C.-1400° C., thus promoting chemical reactions, and causing the formation of consolidated glass inside of the tube 63. PCVD apparatus are taught in U.S. Pat. No. 4,877,938 and U.S. Pat. No. 4,714,589, for example. The dopants introduced are provided in such amounts as to provide at least one up-doped and at least one down-doped segment, as shown in FIG. 24. Similar to the MCVD process, any suitable motor 49 rotates the tube 63 and any suitable traverse assembly (not shown) moves the generator 69 back and forth (as indicated by arrow D) along the length of the tube 63.

### EXAMPLE

A silica glass core cane doped with GeO₂ was placed in a General Electric GE-098 glass tube to form an assembly. The core cane had an outside diameter of 9.8 mm. The glass tube had an outside diameter of 25 mm and an inside diameter of 21 mm. An alkali metal compound chamber was formed at a first end of the glass tube comprising the assembly. The chamber was loaded with approximately 50 g of KBr. The assembly was movably and vertically supported in a conventional draw furnace. A separate furnace was used to surround and heat the KBr chamber. The KBr chamber furnace was used to heat the KBr to a temperature of about 600° C. The draw furnace was heated to a temperature of about 2100° C. The assembly downstream of the chamber was passed through the draw furnace at a downfeed rate of approximately 7 cm/min to fire polish the assembly, thereby removing contaminants which might be adhered to the glass surfaces, and smoothing the glass surfaces. Unless otherwise noted, each return pass (return to the initial starting position) throughout the process was accomplished by withdrawing the assembly through the furnace at a rate of about 25 cm/min.

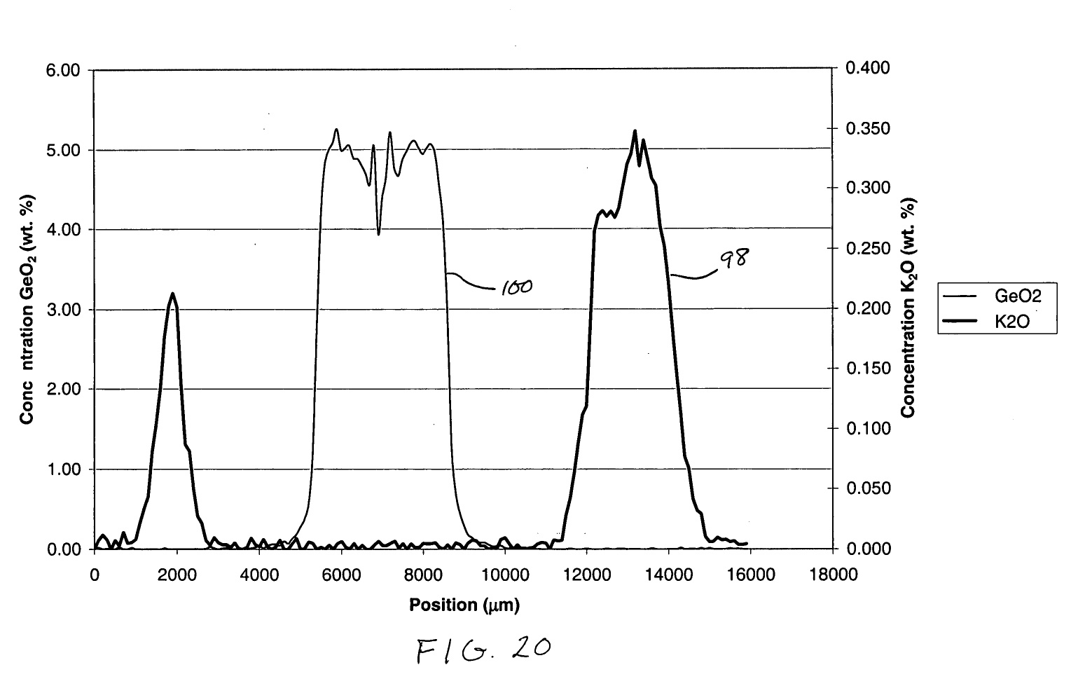

Once the fire polish step was completed, the KBr was heated to a temperature of about 1000° C. The draw furnace was heated to a temperature of about 2040° C. The assembly downstream of the KBr chamber was passed through the draw furnace at a downfeed rate of about 2.5 cm/min. The carrier gas flow through the KBR chamber and the interstitial region of the assembly between the core cane and the glass tube was about 1 SLPM. The carrier gas was 100% oxygen. A second pass was made with a draw furnace temperature of about 2060° C. The downfeed rate of the second pass was approximately 2.5 cm/min. The carrier gas flow rate was 1 SLPM. A third pass was made with the draw furnace at a temperature of about 2080° C. The carrier gas flow rate was 1 SLPM and the downfeed rate was about 2.5 cm/min. At the completion of the third pass, the KBR chamber furnace temperature was reduced to 600° C. The draw furnace temperature was increased to 2100° C. and the assembly downstream of the KBr chamber was passed through the draw furnace at a downfeed rate of 2.5 cm/min to collapse the assembly and close the space between the core cane and the glass tube. The carrier gas flow rate was maintained at 1 SLPM. The downfeed rate during the first collapse pass was 2.5 cm/min. A second collapse pass was made with the draw furnace temperature maintained at 2100° C. The downfeed rate of the assembly was about 2 cm/min, and the carrier gas flow rate was 1 SLPM. A third collapse pass was made with the draw furnace temperature maintained at 2100° C. The downfeed rate was reduced to 2 cm/min, and the carrier gas flow rate was maintained at 1 SLPM. A seal pass was made with the draw furnace temperature at 2100° C. to ensure adequate sealing of the the assembly. The downfeed rate of the assembly was reduced to about 1.5 cm/min. The carrier gas flow rate was 1 SLPM. The resulting K₂O doped rod was measured across a diameter of the rod for the concentration of K₂O and GeO₂ using an electron microprobe. A plot of the concentration of K₂O (98) and GeO₂ (100) contained in the rod as a function of position across the rod diameter is shown in FIG. 20. FIG. 20 shows a core region doped with GeO₂ in a peak amount of about 5 wt. %. The rod also contains K₂O as a ring surrounding the core region. The K₂O is in a peak amount of about 0.33 wt. %.

1. A method of making an optical fiber preform comprising the steps of:
inserting a first glass rod into a first glass tube;
heating the first glass rod and the first glass tube; and
flowing a carrier gas comprising oxygen and an alkali metal vapor between the first glass rod and the first glass tube wherein the alkali metal vapor comprises an alkali metal selected from the group consisting of K, Na, Li, Cs, Rb, and combinations thereof.

2. The method according to claim 1 further comprising the step of collapsing the first glass tube onto the first glass rod to form a second glass rod.

3. The method according to claim 2 wherein the second glass rod comprises a peak alkali metal oxide concentration greater than about 0.01 wt. %.

4. The method according to claim 2 wherein the second glass rod comprises a peak alkali metal oxide concentration greater than about 0.1 wt. %.

5. The method according to claim 1 further comprising the step of removing the first glass rod from the first glass tube.

6. The method according to claim 2 further comprising the step of drawing the second glass rod to form a third glass rod.

7. The method according to claim 5 further comprising the step of forming additional glass on the first glass rod.

8. The method according to claim 7 wherein forming additional glass comprises depositing glass soot.

9. The method according to claim 1 wherein the first glass rod comprises GeO₂.

10. The method according to claim 1 wherein the first glass tube comprises F.

11. The method according to claim 1 wherein the first glass rod in the inserting step comprises less than about 20 ppb by weight OH.

12. The method according to claim 1 wherein the first glass rod in the inserting step comprises less than about 0.05 wt. % chlorine.

13. The method according to claim 6 further comprising the step of forming additional glass on the third glass rod to form an optical fiber preform.

14. The method according to claim 13 further comprising the step of drawing the optical fiber preform into an optical fiber.

15. The method according to claim 1 further comprising the step of forming additional glass on an inside surface of the first glass tube prior to the inserting step.
